(19) United States
(12) Patent Application Publication
(10) Pub. No.: US 2006/0060565 A9
(43) Pub. Date: Mar. 23, 2006

(54) Method of etching metals with high selectivity to hafnium-based dielectric materials

(75) Inventors: Padmapani C. Nallan, San Jose, CA (US); Ajay Kumar, Sunnyvale, CA (US); Guangxiang Jin, San Jose, CA (US)

Correspondence Address: MOSER IP LAW GROUP / APPLIED MATERIALS, INC., 1040 BROAD STREET, 2ND FLOOR, SHREWSBURY, NJ, 07702, US

(73) Assignee: Applied Materials, Inc.

(21) Appl. No.: 10/418,994

(22) Filed: Apr. 17, 2003

Related U.S. Application Data
(63) Continuation-in-part of application No. 10/245,130, filed on Sep. 16, 2002, now Pat. No. 6,759,286.

(51) Int. Cl. C23F 1/00; B44C 1/22; C03C 15/00; C03C 25/68

(52) U.S. Cl. 216/67

(57) ABSTRACT

A method of plasma etching a metal layer (e.g., titanium (Ti), tantalum (Ta), tungsten (W), and the like) or a metal-containing layer (e.g., tantalum silicon nitride (TaSiN), titanium nitride (TiN), tungsten nitride (WN), and the like) formed on a hafnium-based dielectric material is disclosed. The metal/metal-containing layer is etched using a gas mixture comprising a halogen-containing gas and a fluorine-containing gas. The fluorine within the gas mixture provides a high etch selectivity for the hafnium-based dielectric material.

### BACKGROUND OF THE INVENTION

1. Field of the Invention

The present invention generally relates to a method for fabricating devices on semiconductor substrates. More specifically, the present invention relates to a method for etching metals formed on hafnium-based dielectric materials.

2. Description of the Related Art

Ultra-large-scale integrated (ULSI) circuits typically include more than one million transistors that are formed on a semiconductor substrate and which cooperate to perform various functions within an electronic device. Such transistors may include complementary metal-oxide-semiconductor (CMOS) field effect transistors.

A CMOS transistor includes a gate structure that is disposed between a source region and a drain region defined in the semiconductor substrate. The gate structure generally comprises a gate electrode formed on gate dielectric material. The gate electrode controls a flow of charge carriers, beneath the gate dielectric material, in a channel region formed between the drain region and the source region, so as to turn the transistor on or off.

The gate dielectric material typically comprises a thin layer (e.g., 20 to 60 Angstroms) of a high dielectric constant material (e.g., a dielectric constant greater than 4.0) such as, hafnium dioxide (HfO₂), hafnium silicon dioxide (HfSiO₂), hafnium silicon oxynitride (HfSiON), and the like. Such dielectric materials having a dielectric constant greater than 4.0 are referred to in the art as “high-K” materials. In advanced CMOS transistors, the gate electrode is formed of a conductive material (e.g., polysilicon). In addition, the gate electrode may be formed of a metal layer (e.g., titanium (Ti), tantalum (Ta), and the like) or a metal-containing compound layer (e.g., tantalum silicon nitride (TaSiN), titanium nitride (TiN), and the like) that is used to speed up the gate structure.

The CMOS transistor may be fabricated by defining source and drain regions in the semiconductor substrate (e.g., doping regions in the substrate using an ion implantation process). Thereafter, the material layers that comprise the gate (high-K dielectric layer and metal gate electrode layer) are deposited on the substrate and patterned using sequential plasma-etch processes to form the gate structure.

However, many processes that are used to etch metal layers (e.g., titanium (Ti), tantalum (Ta), titanium nitride (TiN) and tantalum nitride (TaN)) typically have a low etch selectivity for underlying thin layers of hafnium-based high-K dielectric materials (e.g., hafnium dioxide (HfO₂), hafnium silicon dioxide (HfSiO₂), hafnium silicon oxynitride (HfSiON)). The low etch selectivity for the hafnium-based dielectric materials may erode or damage such gate dielectric layers rendering the CMOS transistor inoperable.

Therefore, there is a need in the art for a method of etching metals and metal-containing conductive compounds with high selectivity for hafnium-based high-K dielectric materials.

### SUMMARY OF THE INVENTION

The present invention is a method of plasma etching a metal layer (e.g., titanium (Ti), tantalum (Ta), tungsten (W), and the like) or a metal-containing layer (e.g., tantalum silicon nitride (TaSiN), titanium nitride (TiN), tungsten nitride (WN), and the like) formed on a hafnium-based dielectric material. The metal/metal-containing layer is etched using a gas mixture comprising a halogen-containing gas and a fluorine-containing gas. The fluorine within the gas mixture provides a high etch selectivity for the hafnium-based dielectric material.

### BRIEF DESCRIPTION OF THE DRAWINGS

The teachings of the present invention can be readily understood by considering the following detailed description in conjunction with the accompanying drawings, in which:

FIG. 1 depicts a flow diagram of a method for fabricating a gate structure of a field effect transistor in accordance with one embodiment of the present invention;

FIGS. 2A-2E depict a sequence of schematic, cross-sectional views of a substrate having the gate structure being formed in accordance with the method of FIG. 1; and

FIG. 3 depicts a schematic diagram of an exemplary plasma processing apparatus of the kind used in performing portions of the inventive method.

To facilitate understanding, identical reference numerals have been used, where possible, to designate identical elements that are common to the figures.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention is a method of plasma etching a metal layer (e.g., titanium (Ti), tantalum (Ta), and the like) or a metal-containing layer (e.g., tantalum silicon nitride (TaSiN), titanium nitride (TiN), and the like) formed on a hafnium-based dielectric material. The metal/metal-containing layer is etched using a gas mixture comprising a halogen-containing gas and a fluorine-containing gas. The fluorine within the mixture provides a high etch selectivity for the hafnium-based dielectric material.

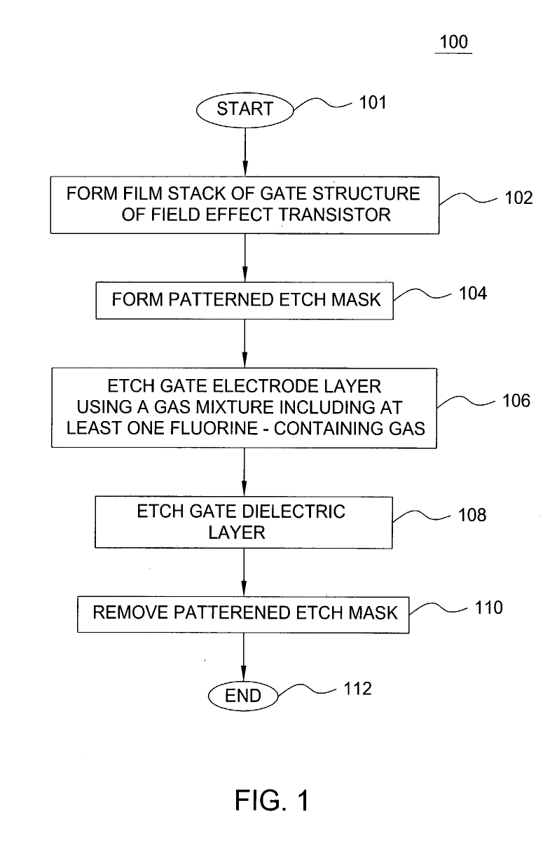

FIG. 1 depicts a flow diagram of one embodiment of the inventive method for fabricating a gate structure of a CMOS transistor as sequence 100. The sequence 100 includes the processes that are performed upon a film stack of the gate structure during fabrication of the CMOS transistor.

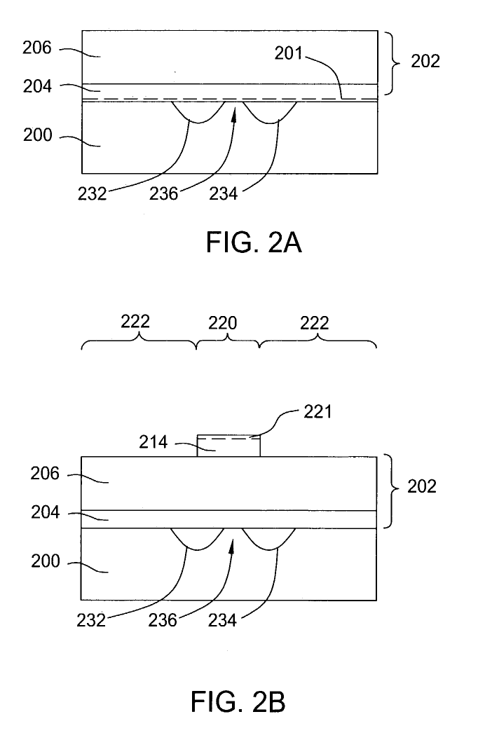

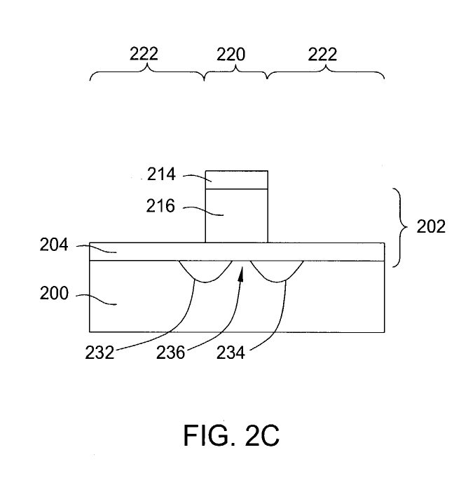

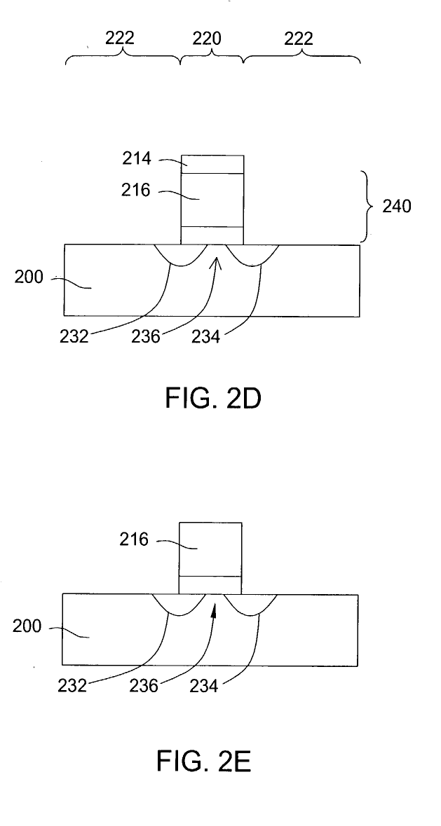

FIGS. 2A-2F depict a series of schematic, cross-sectional views of a substrate having a film stack of the gate structure being fabricated using sequence 100. The cross-sectional views in FIGS. 2A-2F relate to individual processing steps used to fabricated the gate structure. To best understand the invention, the reader should simultaneously refer to FIG. 1 and FIGS. 2A-2F. Sub-processes and lithographic routines (e.g., exposure and development of photoresist, wafer cleaning procedures, and the like) are well known in the art and, as such, are not shown in FIG. 1 and FIGS. 2A-2F. The images in FIGS. 2A-2F are not depicted to scale and are simplified for illustrative purposes.

The sequence 100 starts at step 101 and proceeds to step 102, when a gate film stack 202 is formed on a substrate 200 (FIG. 2A). The substrate 200 (e.g., a silicon (Si) wafer, and the like) comprises doped source regions (wells) 232 and drain regions (wells) 234 that are separated by a channel region 236. In an alternate embodiment, the substrate 200 may further comprise a barrier film 201 (shown in broken line in FIG. 2A only) used to protect the channel region 236 from contaminants (e.g., oxygen (O₂)) that may diffuse therein from the gate film stack 202. The barrier film 201 may comprise a dielectric material such as silicon dioxide (SiO₂), silicon nitride (Si₃N₄), and the like.

The gate film stack 202 generally comprises a gate electrode layer 206 and a gate dielectric layer 204. The gate electrode layer 206 may comprise a metal and/or a metal-containing compound. In one exemplary embodiment, the gate electrode layer 206 is formed of tantalum silicon nitride (TaSiN) to a thickness of about 100 to 2000 Angstroms. In alternate embodiments, the gate electrode layer 206 may comprise metals such as titanium (Ti), tantalum (Ta), and the like, and/or metal-containing compounds, such as tantalum nitride (TaN), titanium nitride (TiN), tantalum silicon nitride (TaSiN), titanium silicon nitride (TiSiN), and the like.

The gate dielectric layer 204 is formed of a hafnium-based dielectric material. In one exemplary embodiment, the gate dielectric layer 204 is formed of hafnium dioxide (HfO₂) to a thickness of about 10 to 60 Angstroms. Alternatively, the gate dielectric layer 204 may comprise hafnium-based dielectric materials, such as hafnium silicon dioxide (HfSiO₂), hafnium silicon oxynitride (HfSiON), and the like.

The layers that comprise the gate film stack 202 may be formed using any conventional deposition technique, such as atomic layer deposition (ALD), physical vapor deposition (PVD), chemical vapor deposition (CVD), plasma enhanced CVD (PECVD), and the like. Fabrication of the CMOS field effect transistors may be performed using the respective processing modules of CENTURA®, ENDURA®, and other semiconductor wafer processing systems available from Applied Materials, Inc. of Santa Clara, Calif.

At step 104, a patterned mask 214 is formed on the gate electrode layer 206 in the region 220 (FIG. 2B). The patterned mask 214 defines the location and topographic dimensions of the gate structure being formed. In the depicted embodiment, the patterned mask 214 protects the channel region 236 and portions of the source region 232 and the drain region 234 (region 220), while exposing adjacent regions 222 of the gate film stack 202.

The patterned mask 214 is generally a hard mask formed of a material that is resistant to etchants used during fabrication of the gate structure, and which are stable at temperatures of up to 350 degrees Celsius. Temperatures up to 350 degrees Celsius may be used for etching the gate dielectric layer 204 (discussed below with reference to step 108). The patterned mask 214 may comprise high-K dielectric materials, such as, silicon dioxide (SiO₂), amorphous carbon (α-carbon), Advanced Patterning Film™ (APF) (available from Applied Materials, Inc. of Santa Clara, Calif.), and the like. In one illustrative embodiment, the patterned mask 214 is formed of silicon dioxide (SiO₂).

The patterned mask 214 may further comprise an optional anti-reflective layer 221 (shown with broken lines in FIG. 2B only) that controls the reflection of light used to pattern the mask. As feature sizes are reduced, inaccuracies in an etch mask pattern transfer process can arise from optical limitations that are inherent to the lithographic process, such as light reflection. The anti-reflective layer 221 may comprise, for example, silicon nitride (Si₃N₄), polyamides, and the like.

Processes of applying the patterned mask 214 are described, for example, in commonly assigned U.S. patent application Ser. No. 10/245,130, filed Sep. 16, 2002 (Attorney docket number 7524) and Ser. No. 10/338,251, filed Jan. 6, 2003 (Attorney docket number 7867), which are incorporated herein by reference.

At step 106, the gate electrode layer 206 is etched and removed in regions 222 forming a gate electrode 216 (FIG. 2C). The gate electrode layer 206 is etched using a gas mixture comprising a halogen-containing gas and a fluorine-containing gas having a formula, C_{X}F_{Y}, where x and y are integers, C_{Z}H_{X}F_{Y}, where x, y and z are integers, and the like. The fluorine-containing gas may comprise for example carbon tetrafluoride (CF₄), fluorobutylene (C₄F₈) and trifluoromethane (CHF₃), and the like. The gas mixture may optionally include one or more inert gases such as, at least one of argon (Ar), helium (He), neon (Ne), and the like. The fluorine-containing gas in the gas mixture facilitates a high etch selectivity for the hafnium-based dielectric material (layer 204) over the metal gate electrode (layer 206) of about 1:20. Step 106 uses the patterned mask 214 as an etch mask and the gate dielectric layer 204 (e.g., hafnium dioxide layer) as an etch stop layer.

Step 106 can be performed in an etch reactor such as a Decoupled Plasma Source (DPS) II module or a Decoupled Plasma Source-High Temperature (DPS-HT) module of the CENTURA® system, commercially available from Applied Materials, Inc. of Santa Clara, Calif. The DPS II reactor uses a power source (i.e., an inductively coupled antenna) to produce a high-density inductively coupled plasma. The DPS-HT module and DPS II module each have generally similar configurations, however, substrate temperature in the DPS-HT module may be controlled within a range from about 200 to 350 degrees Celsius. To determine the endpoint of the etch process, the DPS-HT module and DPS II module may also include an endpoint detection system that monitors plasma emissions at a particular wavelength, controls the process time, or performs laser interferometery, and the like.

In one illustrative embodiment, the gate electrode layer 206 comprising tantalum silicon nitride (TaSiN) is etched in the DPS-HT reactor by providing carbon tetrafluoride (CF₄) at a rate of 10 to 200 sccm, argon (Ar) at a rate of 10 to 200 sccm, applying power to an inductively coupled antenna between 200 and 3000 W, applying a cathode bias power between 0 and 300 W and maintaining a wafer temperature between 10 and 350 degrees Celsius at a pressure in the process chamber between 2 and 50 mTorr. One exemplary process provides carbon tetrafluoride (CF₄) at a rate of 100 sccm, Ar at a rate of 20 sccm, applies 1000 W of power to the inductively coupled antenna, 50 W of cathode bias power and maintains a wafer temperature of 50 degrees Celsius at a chamber pressure of 4 mTorr. Such a process provides etch selectivity for tantalum silicon nitride (TaSiN) (layer 206) over hafnium dioxide (HfO₂) (layer 204) of at least 20:1.

At step 108, the gate dielectric layer 204 is etched and removed in regions 222, thereby forming a gate structure 240 in region 220 (FIG. 2D). In one exemplary embodiment, step 108 uses a gas mixture comprising a halogen gas (e.g., chlorine (Cl₂), hydrogen chloride (HCl), and the like) along with a reducing gas (e.g., carbon monoxide (CO), and the like) for etching the hafnium dioxide (HfO₂) dielectric layer 204. Step 108 uses the patterned mask 214 as an etch mask and the material comprising the substrate 200 (e.g., silicon) as an etch stop layer.

In one illustrative embodiment, the gate dielectric layer 204 comprising hafnium dioxide is etched in the DPS-HT module using a gas mixture including chlorine (Cl₂) at a rate of 2 to 300 sccm, carbon monoxide (CO) at a rate of 2 to 200 sccm (e.g., a Cl₂:CO flow ratio ranging from 1:5 to 5:1), applying power to an inductively coupled antenna between 200 and 3000 W, applying a cathode bias power between 0 and 300 W, and maintaining a wafer temperature between 200 and 350 degrees Celsius at a pressure in the process chamber between 2 and 100 mTorr. One illustrative process provides chlorine (Cl₂) at a rate of 40 sccm, carbon monoxide (CO) at a rate of 40 sccm (i.e., a Cl₂:CO flow ratio of about 1:1), applies 1100 W of power to the inductively coupled antenna, 20 W of bias power to the cathode and maintains a wafer temperature of 350 degrees Celsius at a chamber pressure of 4 mTorr. Such a process provides etch selectivity for the hafnium dioxide (layer 204) over silicon (substrate 200) of at least 3:1, as well as etch selectivity for hafnium dioxide over silicon dioxide (SiO₂) (mask 214) of about 30:1.

At step 110, the patterned mask 214 is, optionally, removed from the gate structure 240 (FIG. 2E). Processes for removing the patterned mask 214 are described, for example, in commonly assigned U.S. patent application Ser. No. 10/245,130, filed Sep. 16, 2002 (Attorney docket number 7524) and Ser. No. 10/338,251, filed Jan. 6, 2003 (Attorney docket number 7867), which are incorporated herein by reference.

At step 112, the sequence 100 ends.

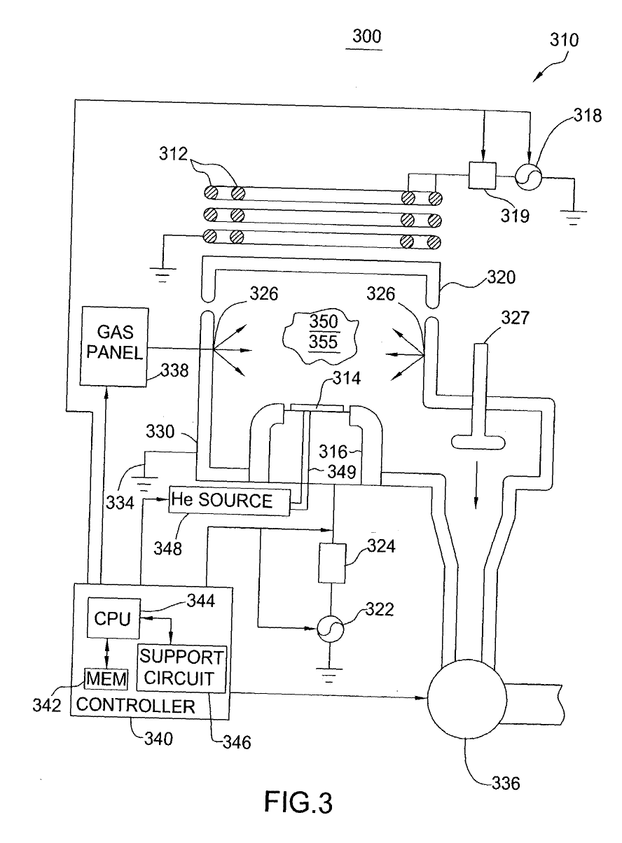

FIG. 3 depicts a schematic diagram of the exemplary Decoupled Plasma Source (DPS) II or DPS-HT etch reactor 300 that may be used to practice portions of the invention. The DPS II and DPS-HT reactors are generally used as processing modules of the CENTURA® system available from Applied Materials, Inc. of Santa Clara, Calif.

The reactor 300 comprises a process chamber 310 having a wafer support pedestal 316 within a conductive body (wall) 330, and a controller 340.

The chamber 310 is supplied with a substantially flat dielectric ceiling 320 (e.g., DPS II, DPS-HT modules). Other modifications of the chamber 310 may have other types of ceilings, e.g., a dome-shaped ceiling (e.g., DPS Plus module). Above the ceiling 320 is disposed an antenna comprising at least one inductive coil element 312 (two co-axial elements 312 are shown). The inductive coil element 312 is coupled, through a first matching network 319, to a plasma power source 318. The plasma source 318 typically is capable of producing up to 3000 W at a tunable frequency in a range from 50 kHz to 13.56 MHz.

The support pedestal (cathode) 316 is coupled, through a second matching network 324, to a biasing power source 322. The biasing source 322 generally is capable of producing up to 500 W at a frequency of approximately 13.56 MHz. The biasing power may be either continuous or pulsed power. In other embodiments, the biasing power source 322 may be a DC or pulsed DC source.

A controller 340 comprises a central processing unit (CPU) 344, a memory 342, and support circuits 346 for the CPU 344 and facilitates control of the components of the chamber 310 and, as such, of the etch process, as discussed below in further detail.

In operation, a semiconductor wafer 314 is placed on the pedestal 316 and process gases are supplied from a gas panel 338 through entry ports 326 and form a gaseous mixture 350. The gaseous mixture 350 is ignited into a plasma 355 in the chamber 310 by applying power from the plasma source 318 and biasing power source 322 to the inductive coil element 312 and the cathode 316, respectively. The pressure within the interior of the chamber 310 is controlled using a throttle valve 327 and a vacuum pump 336. Typically, the chamber wall 330 is coupled to an electrical ground 334. The temperature of the wall 330 is controlled using liquid-containing conduits (not shown) that run through the wall 330.

The temperature of the wafer 314 is controlled by stabilizing a temperature of the support pedestal 316. In one embodiment, the helium gas from a gas source 348 is provided via a gas conduit 349 to channels (not shown) formed in the pedestal surface under the wafer 314. The helium gas is used to facilitate heat transfer between the pedestal 316 and the wafer 314. During processing, the pedestal 316 may be heated by a resistive heater (not shown) within the pedestal to a steady state temperature and then the helium gas facilitates uniform heating of the wafer 314. Using such thermal control, the wafer 314 is maintained at a temperature of between about 20 and 80 degrees Celsius for the DPS II module or about 200 and 350 degrees Celsius for the DPS-HT module.

Those skilled in the art will understand that other etch chambers may be used to practice the invention, including chambers with remote plasma sources, electron cyclotron resonance (ECR) plasma chambers, and the like.

To facilitate control of the process chamber 310 as described above, the controller 340 may be one of any form of general-purpose computer processor that can be used in an industrial setting for controlling various chambers and sub-processors. The memory 342, or computer-readable medium, of the CPU 344 may be one or more of readily available memory such as random access memory (RAM), read only memory (ROM), floppy disk, hard disk, or any other form of digital storage, local or remote. The support circuits 346 are coupled to the CPU 344 for supporting the processor in a conventional manner. These circuits include cache, power supplies, clock circuits, input/output circuitry and subsystems, and the like. The inventive method is generally stored in the memory 342 as a software routine. The software routine may also be stored and/or executed by a second CPU (not shown) that is remotely located from the hardware being controlled by the CPU 344.

The invention may be practiced using other semiconductor wafer processing systems wherein the processing parameters may be adjusted to achieve acceptable characteristics by those skilled in the art by utilizing the teachings disclosed herein without departing from the spirit of the invention.

Although the forgoing discussion referred to fabrication of one metal gate electrodes (e.g., tantalum silicon nitride (TaSiN)) field effect transistors, dual metal gate electrodes (e.g., tantalum silicon nitride/titanium nitride (TaSiN/TiN)) may also be formed using the invention. Additionally, fabrication of other devices and structures used in integrated circuits can benefit from the invention.

While the foregoing is directed to the illustrative embodiment of the present invention, other and further embodiments of the invention may be devised without departing from the basic scope thereof, and the scope thereof is determined by the claims that follow.

What is claimed is:

1. A method for etching a metal-containing layer, comprising:
providing a substrate having a metal-containing layer formed on a hafnium-based layer; and
plasma etching the metal-containing layer using a gas mixture comprising a halogen-containing gas and a fluorine-containing gas.

2. The method of claim 1 wherein the hafnium-based layer is selected from the group consisting of hafnium dioxide (HfO₂), hafnium silicon dioxide (HfSiO₂) and hafnium silicon oxynitride (HfSiON).

3. The method of claim 1 wherein the metal-containing layer is selected from the group consisting of titanium (Ti), titanium nitride (TiN), tantalum (Ta), tantalum silicon nitride (TaSiN), tungsten (W) and tungsten (WN).

4. The method of claim 1 wherein the fluorine-containing gas has a formula C_{X}F_{Y}, wherein x and y are integers.

5. The method of claim 1 wherein the fluorine-containing gas has a formula C_{Z}H_{X}F_{Y}, where x, y and z are integers.

6. The method of claim 1 wherein the fluorine-containing gas comprises a gas selected from the group consisting of carbon tetrafluoride (CF₄), fluorobutylene (C₄F₈) and trifluoromethane (CHF₃).

7. The method of claim 1 wherein the gas mixture has a selectivity for the hafnium-based material over the metal-containing layer of 1:20.

8. The method of claim 1 wherein the metal-containing layer is plasma etched by:
providing carbon tetrafluoride (CF₄) and argon (Ar) at a CF₄:Ar flow ratio in a range from 1:20 to 20:1;
applying a plasma power of between about 200 and 3000 W;
applying a substrate bias power of not greater than about 300 W; and
maintaining the substrate at a temperature between about 10 and 350 degrees Celsius at a chamber pressure of between about 2 and 50 mTorr.

9. A method for forming a gate structure of a field effect transistor, comprising:
(a) providing a substrate having a gate electrode layer formed on a hafnium-based dielectric layer over a plurality of transistor junctions defined on the substrate;
(b) forming a patterned mask defining a gate structure on the gate electrode layer;
(c) plasma etching the gate electrode layer using a gas mixture comprising a halogen-containing gas and a fluorine-containing gas; and
(d) plasma etching the hafnium-based dielectric layer to form the gate structure on the substrate.

10. The method of claim 9 wherein the hafnium-based dielectric layer is selected from the group consisting of hafnium dioxide (HfO₂), hafnium silicon dioxide (HfSiO₂) and hafnium silicon oxynitride (HfSiON).

11. The method of claim 9 wherein the gate electrode layer comprises a metal-containing layer.

12. The method of claim 11 wherein the metal-containing layer is selected from the group consisting of titanium (Ti), titanium nitride (TiN), tantalum (Ta), tantalum silicon nitride (TaSiN), tungsten (W) and tungsten (WN).

13. The method of claim 9 wherein the fluorine-containing gas has a formula C_{X}F_{Y}, wherein x and y are integers.

14. The method of claim 9 wherein the fluorine-containing gas has a formula C_{Z}H_{X}F_{Y}, where x, y and z are integers.

15. The method of claim 9 wherein the fluorine-containing gas comprises a gas selected from the group consisting of carbon tetrafluoride (CF₄), fluorobutylene (C₄F₈) and trifluoromethane (CHF₃).

16. The method of claim 9 wherein the gas mixture has a selectivity for the hafnium-based material over the metal-containing layer of 1:20.

17. The method of claim 11 wherein the gate electrode layer is plasma etched by:
providing carbon tetrafluoride (CF₄) and argon (Ar) at a CF₄:Ar flow ratio in a range from 1:20 to 20:1;
applying a plasma power of between about 200 and 3000 W;
applying a substrate bias power of not greater than about 300 W; and
maintaining the substrate at a temperature between about 10 and 350 degrees Celsius at a chamber pressure of between about 2 and 50 mTorr.

18. A computer-readable medium containing software that when executed by a computer causes a semiconductor wafer processing system to etch a metal-containing layer, comprising:
providing a substrate having a metal-containing layer formed on a hafnium-based layer; and
plasma etching the metal-containing layer using a gas mixture comprising a halogen-containing gas and a fluorine-containing gas.

19. The computer-readable medium of claim 18 wherein the hafnium-based layer is selected from the group consisting of hafnium dioxide (HfO₂), hafnium silicon dioxide (HfSiO₂) and hafnium silicon oxynitride (HfSiON).

20. The computer-readable medium of claim 18 wherein the metal-containing layer is selected from the group consisting of titanium (Ti), titanium nitride (TiN), tantalum (Ta), tantalum silicon nitride (TaSiN), tungsten (W) and tungsten (WN).

21. The computer-readable medium of claim 18 wherein the fluorine-containing gas has a formula C_{X}F_{Y}, wherein x and y are integers.

22. The computer-readable medium of claim 18 wherein the fluorine-containing gas has a formula C_{Z}H_{X}F_{Y}, where x, y and z are integers.

23. The computer-readable medium of claim 18 wherein the fluorine-containing gas comprises a gas selected from the group consisting of carbon tetrafluoride (CF₄), fluorobutylene (C₄F₈) and trifluoromethane (CHF₃).

24. The computer-readable medium of claim 22 wherein the gas mixture has a selectivity for the hafnium-based material over the metal-containing layer of 1:20.
